(19) United States
(12) Patent Application Publication
(10) Pub. No.: US 2011/0225086 A1
(43) Pub. Date: Sep. 15, 2011

(54) CREDIT PROVISION SYSTEM AND METHOD

(76) Inventors: Alex D. Ibasco, Makati City (PH); Alexander G. Seminiano, Makati City (PH); Oliver L. Ubalde, Makati City (PH); Julie K. Garcia, Makati City (PH); Patrick B. Posadas, Makati City (PH); Vincent C. CO, Makati City (PH); Ric Angelo S. Tan, Makati City (PH)

(21) Appl. No.: 13/130,338

(22) PCT Filed: Nov. 25, 2009
(86) PCT No.: PCT/SG2009/000450

§ 371 Date: May 20, 2011

(30) Foreign Application Priority Data
Nov. 26, 2008 (SG) 200808761-1

(51) Int. Cl. G06Q 30/00; G06Q 40/00

(52) U.S. Cl. 705/40; 705/44; 705/1.1

(57) ABSTRACT

A system and method for providing credit to a subscriber, including a plurality of networks, each of said networks supporting a plurality of subscribers; a central settlement facility coupled to each network within the plurality of networks, said central settlement facility maintaining a plurality of subscriber accounts and wherein the central settlement facility is adapted, on receipt of a request for credit from a subscriber, to convert the request for credit to an intermediate value; obtain credit from a credit provider with said intermediate value; credit an account held by the subscriber on the settlement facility with an amount equivalent to the request for credit; and advise the subscriber of the approval of the request for credit is disclosed. The system is further configured for the provision of airtime to a subscriber.

### FIELD OF THE INVENTION

The present invention relates to systems and methods for providing credit facilities within a communications network. In particular although not exclusively the present invention relates to the provision of airtime recharge services within mobile communication networks.

### DISCUSSION OF THE BACKGROUND ART

Most mobile communications systems at present employ two charging paradigms, post-paid and pre-paid. Most post-paid mobile phone services are provided via a contract between the user and a service provider. Under the post-paid paradigm the user is billed at the end of each billing cycle based on their level of usage.

Under the pre-paid paradigms, the user typically purchases the handset along with a set amount of network credit. The user is then free to access the network until they run out of credit. A user may add more credit to the pre-paid account at any time. This is known as “topping up” the account. This top up can be affected by a credit/debit card transaction with the provider or by purchasing a “top-up card” at a retail outlet. The top-up card is stamped with a unique code (often under a scratch-off panel) which can be redeemed on the phone for credit. Credit for a pre-paid mobile phone may have a time limit, for example 90 days from the date the last credit was added. In these cases, customers who do not add more credit before expiration will lose their remaining balance, and the service (and its associated phone number) may be discontinued.

One problem with the use of pre-paid mobiles is the difficulty in recharging credit when the user is outside their service provider's network (e.g. user is roaming internationally). In such instances users are unable to purchase recharges cards from their particular service provider. However, as mentioned above, the user has the option to recharge credit by utilising credit or debit cards. Typically, this recharge facility is provided in the form of a web portal, dial in service via a pre-programmed service number or SMS service. The dial in and SMS recharge can be particularly problematic if the user has insufficient credit to initiate the call or send the SMS. Likewise the web portal requires the user to be able to access the Internet, consequently there may be significant delays between being notified of lack of credit and recharge during which the user is unable to access the network and in some instances unable to receive calls. The delays can be further exacerbated as the user's home network takes some time to register the update in credit values, further delays can occur as the change in credit values is propagated through to the host network.

Accordingly there is a need for a system and method that would allow for the recharge of mobile credit for a mobile subscriber across multiple mobile service provider platforms that is relatively simple to use and seamless. It would also be advantageous to provide a system and method that not only allows recharging of mobile airtime but also enables the recharge credit to be utilised to purchase additional services or goods.

### SUMMARY OF THE INVENTION

In one aspect of the present invention there is provided a system for providing credit to a subscriber, said system including:

a plurality of networks, each of said networks supporting a plurality of subscribers;

a central settlement facility coupled to each network within the plurality of networks, said central settlement facility maintaining a plurality of subscriber accounts and wherein the central settlement facility is adapted, on receipt of request for credit from a subscriber, to:

convert the request for credit to an intermediate value;

obtain value credit from a credit provider with said intermediate value;

credit in the subscriber's account the amount of the requested credit; and

advise the subscriber of the approval of the request for credit;

The central settlement facility may include at least one server, said server being adapted to maintain the plurality of subscriber accounts and negotiate the provision of credit from a plurality of credit providers to one or more subscribers.

The central settlement facility may be coupled to a foreign exchange trading service to allow conversion of the credit request to the intermediate value. Preferably the requested amount of credit is transmitted to the central settlement facility in the local currency of the network from which the subscriber makes the request. Suitably the intermediate value is the US dollar equivalent of the requested amount of credit. It will be appreciated by those skilled in the art that the central settlement facility may be provided with access to foreign exchange systems (forex) and as such would be capable of selecting multiple currencies for use as the intermediate value. The requested credit amount may be transmitted to the settlement facility by the subscriber via a web portal, SMS, MMS, WAP, On Device Portal (ODP), ATM, POS, Kiosk or USSD command. Where the credit request is transmitted via a mobile handset, the handset may be adapted to provide a set of functional menus to allow the user to input the relevant details of the request. Preferably, the central settlement facility may further contain a central clearing house.

The advice regarding approval of the request for credit may be sent to the subscriber in the form of an email, SMS, MMS, WAP, On Device Portal (ODP), flash message via USSD or STK or the like. Suitably the approval notice includes the amount credited to the subscriber's account and the amount charged to the subscriber for obtaining the requested amount of credit. Preferably the subscriber is charged for the provision of credit by direct debit to the subscriber's or the credit provider's financial institution.

The request for credit may include providing a cash payment for predetermined credit value to a third party, in such instances the system may be configured to transfer credit between the subscriber's account and the third party's subscriber account e.g. third party acts as credit provider. Alternatively the system may be configured to allow the third party to broker the request for credit with the credit provider to obtain the best rate for the subscriber. The system may be configured to credit the third party with a predetermined commission for brokering the provision of credit for the subscriber.

Preferably the credit obtained by the subscriber can be exchanged through the central settlement facility for a number of goods and services offered by one or more third parties registered with the credit facility.

In addition, the central settlement facility may be adapted to obtain information on the location of the subscriber making the request for credit. The settlement facility may also be configured to calculate the appropriate local and international taxes due of the transaction and adjust the sales price, remittance to a seller (i.e. commission), etc.

In a further aspect of the present invention there is provided a system for providing airtime to a subscriber, said system including:

a plurality of networks each of said networks supporting a plurality of subscribers;

a central settlement facility coupled to each network within the plurality of networks, said settlement facility maintaining a plurality of subscriber accounts and wherein the settlement facility is adapted, on receiving a request for additional airtime from a subscriber on a first network, to:

convert the request for airtime to an intermediate value;

obtain airtime from a second network with said intermediate value;

credit the subscriber with the requested amount of airtime; and

advise the subscriber of the approval of the airtime request.

Preferably each of the networks is a mobile communications network, wherein each mobile network may be owned by different mobile service provider. In such instances the subscribers may include mobile subscribers, mobile dealers and retailers of mobile services.

Suitably the first network is the network currently hosting the subscriber and the second network is the subscriber's home network. Alternatively the first and second network may be the same network (i.e. domestic airtime transfer).

The central settlement facility may be coupled to a foreign exchange trading service to allow for the conversion of the airtime request to the intermediate value. Preferably the airtime request is transmitted to the central settlement facility in the local currency of the first network. Suitably the intermediate value is the cost in US dollars of the requested amount of airtime. The central settlement facility, however, would be capable of using multiple currencies or a different currency as the intermediate value. The airtime request may be transmitted to the central settlement facility by the subscriber via a web portal, ATM, POS, Kiosk or via a mobile handset in the form of an SMS, MMS, WAP, ODP or USSD command. Where the airtime request is transmitted via a mobile handset, the handset may be adapted to provide a set of functional menus to allow the user to input the relevant details of the request including but not limited to account id, amount of airtime requested and other relevant information.

The subscriber may be a post-paid customer of the second network. Suitably the system is configured to debit the subscriber's post-paid account on the second network in the local currency of the second network for the cost of the requested amount of airtime. The advice regarding approval of the request for airtime is sent to the subscriber in the form of an email, SMS, MMS flash message on phone via USSD or STK or the like. Suitably the notification includes advice on the amount billed to the subscriber's post-paid account for the provision of the requested airtime.

The subscriber may be a pre-paid customer of the second network. In such an instance, the request for airtime includes debiting the third party subscriber's account with the amount corresponding to the requested airtime, and crediting the subscriber's account with the amount corresponding to said requested airtime in the local currency of the network on which the pre-paid account is maintained. This transaction may involve payment of cash to the third party subscriber, in the currency as may be agreed between the parties, which may be the local currency of the third party subscriber or any acceptable currency, in such amount as may correspond to the requested airtime, and which could be subject to a further mark-up. The advice regarding approval of the request for airtime is sent to the subscriber in the form of an email, SMS, MMS, flash message via USSD or STK or the like. Suitably the notification includes advice on the amount in the local currency of the subscriber's home network the amount of airtime credited to the subscriber's account.

The system may also be adapted to allow the transfer of airtime between subscribers. The transfer of airtime between subscribers may be initiated by sending a keyword or flash message via USSD command to the central settlement facility. The party initiating the transfer may then be required to enter the recipient's mobile number and the amount of airtime the initiating party wishes to transfer to the intended recipient. The system may be further configured to debit the initiating party's home network billing system and to credit the airtime to the recipient's home billing system.

The system may be adapted to provide a predetermined commission to the mobile service provider based on the sale made by mobile dealers and mobile retailers. The system may also provide a predetermined commission to mobile dealers for each sale made to a mobile retailer. Suitably the predetermined commission on each transaction is negotiated by each of the mobile service providers registered with the credit facility.

The system may be adapted to obtain information on the location of the subscriber making the request for additional airtime or transfer of airtime.

In a further aspect of the present invention there is provided a method of facilitating the provision of credit to a selected subscriber via a central settlement facility coupled to a plurality of networks, wherein each of said networks supports a plurality of subscribers said method including the steps of:
receiving at the central settlement facility a request for credit from at least one subscriber;
determining if the subscriber has an account with the central settlement facility;
converting the request for credit to an intermediate value on determining that the subscriber maintains an account with the central settlement facility;
obtaining credit from a credit provider based on the intermediate value;
crediting the subscriber's account with the central settlement facility the amount of requested credit; and
   advising the subscriber of the approval of the request for credit.

Suitably the step of receiving includes receiving a request for credit in the form of a keyword or keywords by way of a web portal, a wireless terminal, an ATM, a POS, or a kiosk. In case of a wireless terminal such as a mobile phone, the request is made via SMS, MMS, WAP, ODP or USSD command in advance of receiving the request for credit.

The step of converting to an intermediate value may include converting the request for credit to an equivalent US dollar amount. Suitably the conversion is performed on the basis of the prevailing forex rates which are not necessarily real-time rates and which can be stored within the system.

Preferably the step of obtaining credit (for post-paid subscribers) includes debiting the credit provider's account on the central settlement facility the amount of the request for credit and billing the subscriber's home network service account. Suitably the step of billing the subscriber's home network service account includes converting the intermediate value to the local currency of the subscriber's home network. Alternatively, for pre-paid subscribers, the credit provider can be paid either directly in cash, or by way of cash or credit card, mobile banking, check, or such other equivalent forms of cash.

The method may further include the step of exchanging the credit contained in a subscriber's account for goods and service provided by third parties registered with the credit facility.

Suitably the step of advising includes sending an electronic notification to the subscriber. The electronic notification may be an SMS, email, MMS, flash message via USSD or STK, or the like. The notification may include information on the amount of credit obtained and the amount billed to the subscriber's home service account for provision of the requested amount of credit.

In another aspect of the present invention there is provided a method of providing airtime to a subscriber of a mobile communications network via a central settlement facility coupled to a plurality of mobile communications networks said method including the steps of:
receiving at the central settlement facility from at least one subscriber on a first network for a airtime request from a second network within the plurality of mobile communications networks coupled to the settlement facility;
determining if the subscriber has an account with the central settlement facility;
converting the request for airtime to an intermediate value on determining that the subscriber maintains an account with the central settlement facility;
obtaining airtime from the second network based on the intermediate value;
crediting in the subscriber's account with the central settlement facility the amount of requested credit; and
   advising the subscriber of the approval of the request for airtime.

Suitably the step of receiving includes receiving a request via SMS, MMS, ATM, POS, kiosk, ODP or USSD command in advance of receiving the request for airtime.

Preferably the first network is the network currently hosting the subscriber and the second network is the subscriber's home network. The first and second network may be the subscriber's home network.

The request for airtime may be in local currency of the first network, and the step of converting to an intermediate value may include converting the request for airtime from the first network currency to an equivalent US dollar amount or to any equivalent amount in the currency or currencies set or chosen.

The subscriber may be a post-paid customer of the second network, accordingly the method may include the step of debiting the subscriber's post-paid account on the second network in the local currency of the second network the amount of request for airtime.

The subscriber may be a pre-paid customer of the second network. In such an instance the method may include the steps of providing a cash payment to a third party within the first network in a first currency, debiting the third party's subscriber account in the amount of the cash payment, and crediting the subscribers pre-paid account in the amount of the cash payment in the local currency of the subscriber's home network on which the pre-paid account is maintained.

Suitably the step of advising includes sending an electronic notification to the subscriber. The electronic notification may be an SMS, email, MMS, flash message via USSD or STK, or the like. The notification may include information on the amount of credit obtained and the amount billed to the subscriber's home service account for provision of the requested amount of airtime.

In another aspect of the present invention there is provided a system for facilitating transactions between subscribers, said system including:
a plurality of networks, each of said networks supporting a plurality of subscribers;
a central settlement facility coupled to each network within the plurality of networks, said settlement facility maintaining a plurality of subscriber accounts and wherein the settlement facility is adapted, on receipt of a request for subscriber, to:
bind one or more credit and/or debit accounts of a subscriber to the account maintained by subscriber on the central settlement facility, wherein binding includes creating a virtual account having a unique set of credentials, said virtual account being utilised by the subscriber to conduct transactions with a plurality of third parties registered with the central settlement facility; and
wherein the central settlement facility is further adapted to negotiate approval of said transactions with the appropriate credit and/or debit accounts of the subscriber bound to the virtual account.

Preferably the creation of the virtual account requires the subscriber to designate a default account from the one or more credit and/or debit accounts via which negotiating approval of all transactions is primarily performed. Suitably, the transactions between the subscriber and third parties may be conducted via a web portal, ATM, POS, kiosk, SMS, MMS, WAP, On Device Portal (ODP) or USSD command.

Preferably the virtual account is link to a physical medium to facilitate transaction with third parties registered with the central settlement facility. The physical medium may be a magnetic stripe card, smart card, contactless card or RFID tag. Alternatively, the physical medium is the subscriber's mobile telephone.

Preferably, the central settlement facility is adapted to create a set of subsidiary accounts from the virtual account, each subsidiary account including a subsidiary settlement account. Each subsidiary accounts may be configured to be associated with a third party selected from the plurality of third parties registered with the central settlement facility. Each subsidiary accounts from the virtual account may also be configured such that the subscriber is required to designate a default account from the one or more credit and/or debit accounts via which negotiating approval of all transactions conducted through the subsidiary settlement accounts is primarily performed. Each subsidiary account may be further configured to be linked to a physical medium to facilitate transaction with the third party associated with the subsidiary account. Preferably, the physical medium is a magnetic stripe card, smart card, contactless card or RFID tag. Alternatively, the physical medium may be the subscriber's mobile telephone. Suitably, the transactions between the subscriber and third parties are conducted via a web portal, ATM, POS, kiosk, SMS, MMS, WAP, On Device Portal (ODP) or USSD command.

In another aspect of the present invention there is provided a method of facilitating transactions between a subscriber and third parties via a central settlement facility coupled to a plurality of networks, wherein each of said networks supports a plurality of subscribers, said method including the steps of:
creating at the central settlement facility a virtual account for the subscriber;
binding one or more credit and/or debit accounts of a subscriber to the virtual account;
conducting via the virtual account transactions with a plurality of third parties registered with the central settlement facility; and
negotiate approval of said transactions with the appropriate credit and/or debit accounts of the subscriber bound to the virtual account.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic diagram illustrating the transfer of credit between users of two networks according to one embodiment of the present invention

FIG. 2 is a schematic diagram illustrating one possible configuration of a credit provision facility according to one embodiment of the present invention

FIG. 3 is a schematic diagram illustrating one possible configuration of airtime provision to a mobile subscriber according to one embodiment of the present invention

FIG. 4 depicts one possible structure for a rate card according to one embodiment of the present invention

FIG. 5 is a schematic diagram illustrating the process steps associated with providing a mobile subscriber with additional credit

FIG. 6 is a schematic diagram illustrating the relationship between network providers, dealers and retailers according to one embodiment of the present invention

FIG. 7 is a schematic diagram illustrating the process steps associated with enrolling a network provider on the credit provision system according to one embodiment of the present invention

FIG. 8 is a schematic diagram illustrating the process steps associated with providing a dealer with credit according to one embodiment of the present invention;

FIG. 9 is a schematic diagram illustrating the process steps associated with providing a retailer with credit according to one embodiment of the present invention

FIGS. 10A and 10B are flow charts illustrating the login and change password processes according to one embodiment of the present invention.

FIG. 11 is a schematic diagram illustrating the transfer of airtime between two mobile subscribers according to one embodiment of the present invention

FIG. 12 is an example of a series of user screens for initiating transfer of airtime from one mobile subscriber to another according to one embodiment of the present invention

FIG. 13 is a schematic diagram illustrating the process steps associated with the transfer of airtime between mobile subscribers

FIG. 14 is a schematic diagram representing another possible application environment for the credit provision system according to one embodiment of the present invention

FIG. 15 is a schematic diagram illustrating one possible configuration of a credit provision system for the purchasing of goods and services according to one embodiment of the present invention.

FIG. 16 is a schematic diagram illustrating one possible configuration of a credit provision system for facilitating transactions between subscribers and third parties according to one embodiment of the present invention.

FIG. 17 is a schematic diagram illustrating one possible configuration of a credit provision system for facilitating transactions between subscribers and third parties according to one embodiment of the present invention.

FIG. 18 is a schematic diagram illustrating one possible configuration of a credit provision system for facilitating transactions between subscribers and third parties according to one embodiment of the present invention, and

FIG. 19 is a schematic diagram depicted how commissions for various transactions may be distributed to all relevant parties according to one embodiment of the invention.

### DESCRIPTION OF EMBODIMENTS OF THE INVENTION

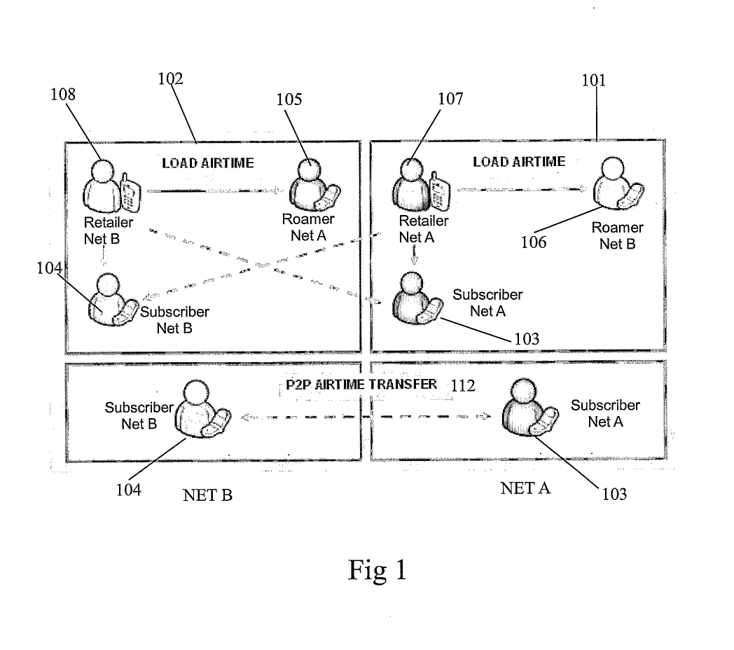

With reference to FIG. 1 there is illustrated an overview of system functionality for the provision of credit to subscribers of the participating communications networks according to one embodiment of the present invention. As shown two networks, network A 101 and network B 102 allow subscribers of network A 103 to roam (roaming subscriber 105) within network B and vice versa (i.e. roaming subscriber 106 in network A).

As is the case with most current pre-paid credit paradigms, subscribers 103, 104 are free to purchase additional airtime from their local retailers 107, 108. Unlike standard pre-paid arrangements, however, the exemplified system in this instance allows for roaming subscribers 105, 106 to purchase additional credit from retailers in the current host network 101, 102. The purchasing of credit outside a subscriber's local network 101, 102 is discussed in greater detail below.

In addition to allowing a subscriber to purchase additional credit outside their local network, the system also allows for the transfer of credit between various subscribers. For example if a subscriber purchases a pre-paid service on network A and the subscriber maintains a post-paid service on network B, any leftover airtime on the pre-paid service could be credited back to the subscribers post-paid service via a suitable transfer process 112 e.g. peer to peer.

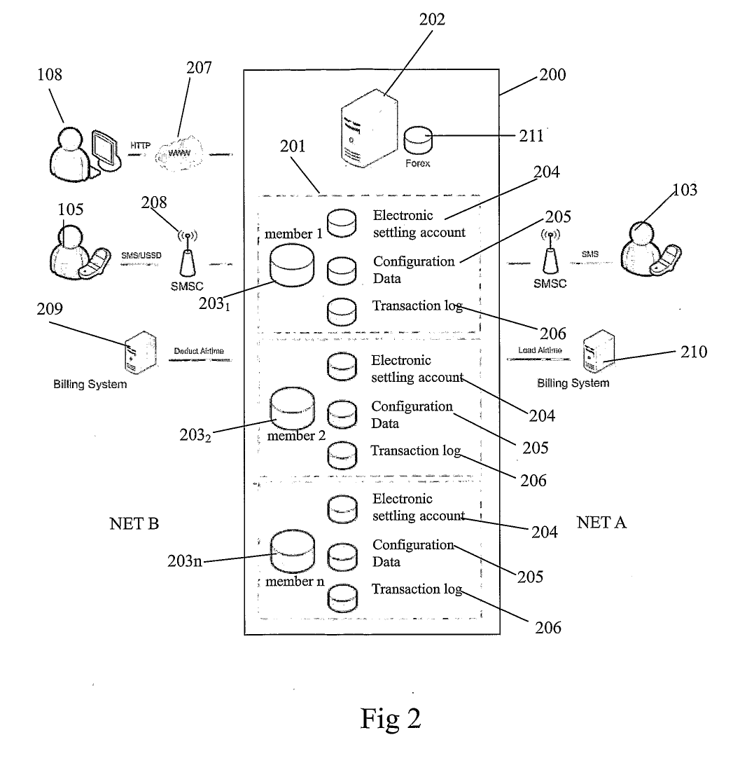

To permit subscribers to purchase airtime from their local network via the current host network the system utilises a central credit facility. An example of one possible arrangement of a centralised settlement facility 200 is illustrated in FIG. 2.

As shown networks A 101, and B 102 are coupled to the settlement facility 200 to permit the transfer of funds associated with a credit request to the Transfer Server (TS) 201 of the settlement facility 200.

The (TS) 201 in this instance is an application running on at least one server 202 disposed within the settlement facility 200. The TS 201 is responsible for co-ordinating the purchasing of airtime by various subscribers, retailers and dealers across both networks. As shown the TS 201 maintains an account for each of the registered users 203₁, 203₂, . . . , 203n. Each account contains a settling account 204 information, configuration data 205 and transaction logs 206.

The settling accounts 204 may include information relating to the amount of available credit for a given user. Indeed for most individual users the settling account simply contains the amount of available credit. However in the case of dealers and retailers the settling account 204 can contain additional information such as commissions and sales and others as may be deemed pertinent (discussed in greater detail below).

The configuration data 205 for each user can include information relating to the network configuration for the particular user, rate card and commissioning scheme etc. The transaction log 206 maintains a log of all transactions for reporting and settlement (system should be able to determine the breakdown or allocation of the transaction amount into sales and commissions)

As illustrated various users (subscribers 103,105 (as seen in FIG. 2) dealers 601a, 601b (not shown) and retailers 107,108) can access the settlement facility 200 in a variety of manners. For instance a user could access the settlement facility via web portal an ATM, a POS or a kiosk 207. Alternatively the user could access the settlement facility 200 via phone 208 keyword, menu, SMS or USSD command. The settlement facility 200 may be coupled to the backend billing systems 209, 210 of network A and network B respectively. On receiving a request for additional credit the settlement facility 200 passes the request to the TS 201 which then processes the request. The appropriate credit value in the user's settling account is adjusted accordingly and the user is billed via his/her home network billing system 209, 210.

As shown in FIG. 2 the settlement facility has access to foreign currency facilities 211. This enables the system to convert the requested amount of credit to a common base rate before forwarding the requested credit value to TS 201 for processing. The manner in which the credit request is processed is discussed in greater detail below.

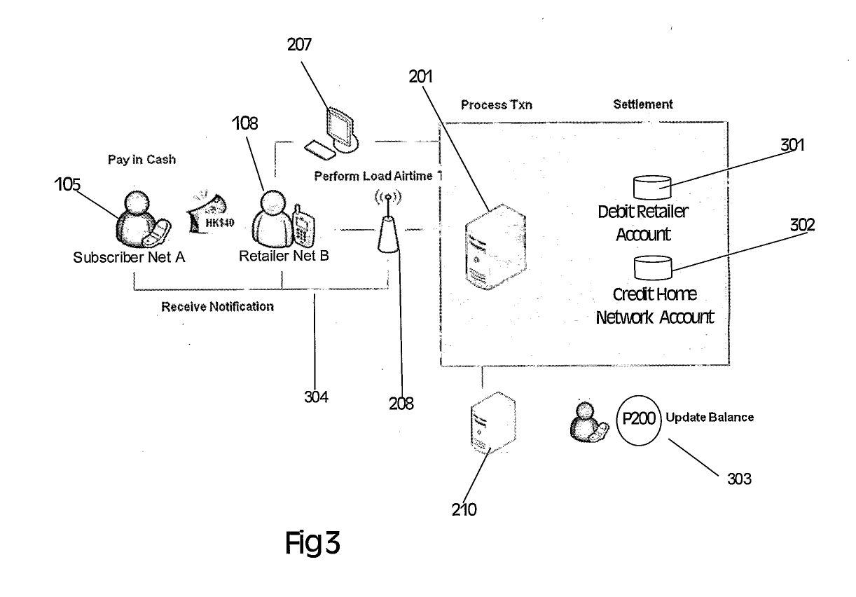

FIG. 3 depicts one example of how the settlement facility 200 can be utilised to effect airtime recharge for a roaming subscribers 105,106 in a host network. As shown the roaming subscriber 105 purchases additional airtime from a retailer 108 with host network 102. The retailer 108 then forwards the purchase request to the settlement facility 200.

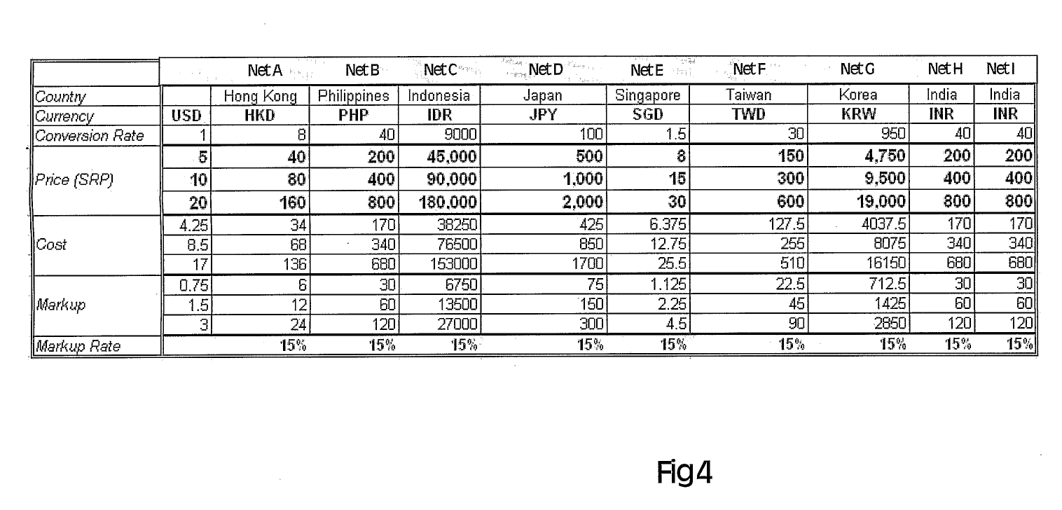

In this particular example, the roaming subscriber 105 requests $HK40 in additional credit. This value is then forwarded to the settlement facility 200. The settlement facility then converts the cash value to an e-value via an Electronic Value Transaction (EVT). In the present example, the EVT involves the conversion of the $HK40 to an equivalent US dollar amount. The US dollar amount can then be equated to an equivalent load denomination offered on the subscriber's home network by the TS 201. The load denominations offered are determined by the relevant networks party to the partnering agreement. These values are stored in a standard rate card. An example of the rate card is shown in FIG. 4. As shown, the rate card lists the minimum load denominations in USD and the applicable currencies of the member networks. The minimum denominations are set in accordance with the Standard Retail Price (SRP) for airtime (in local currency) of each of the participating networks. The SRP is comprised of the Rate Card Cost (Electronic Value equivalent of the airtime being sold, which is inclusive of any applicable tax such as VAT) and the Mark-up (which serves as the Retailer's earnings).

Once the TS 201 has determined the load denomination, it proceeds to debit the retailer's settling account 301 in the amount of credit purchased by the subscriber 105 and credits the user's home network settling account 302 the amount of credit purchased in the home networks local currency based on the values contained in the rate card. The home network 101 then updates the roaming subscriber's airtime credit 303 based on the received funds and sends back an SMS acknowledgement to the retailer and subscriber 304 of the successful completion of the transaction. This acknowledgement could also be in another form or media, such as an email.

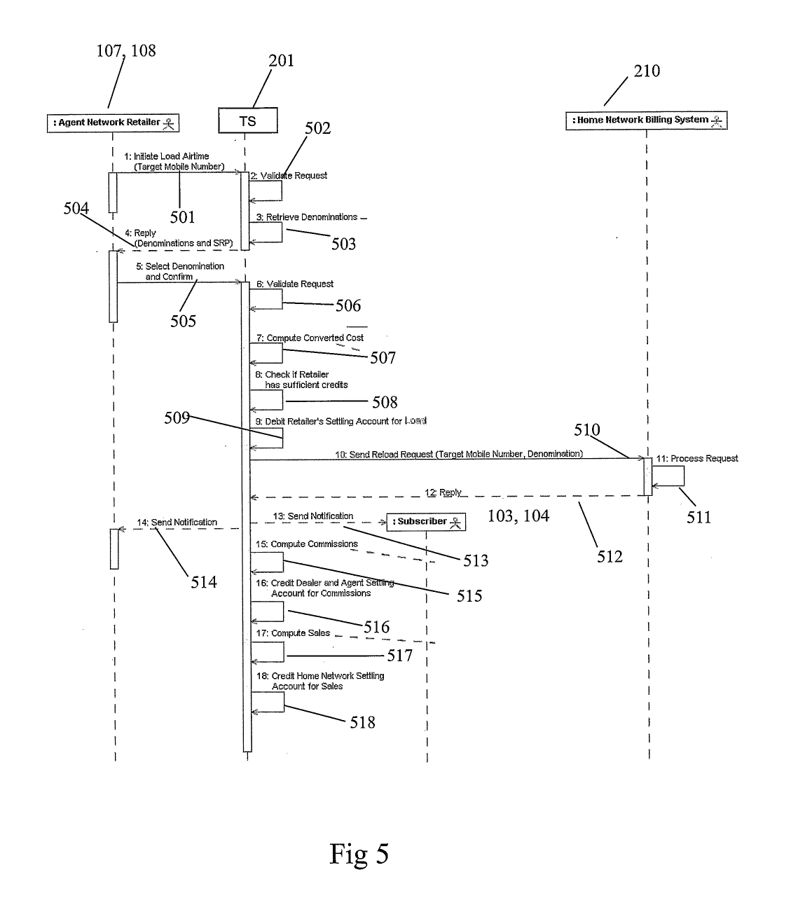

A more detailed view of the process of the inter-network purchasing of additional credit is shown in FIG. 5. Here the subscriber buys airtime from a host network retailer 108; the retailer 108 then sends a load airtime transaction request (step 501) to the TS 201. On receipt of the request the TS 201 performs a validation 502 to determine if the retailer 108 is a validly registered user. At this stage the TS 201 also determines whether the transfer is a domestic or international transfer and whether the retailer is transacting within the host network's country. Once the validation step is complete, the TS 201 then proceeds to retrieve the available denominations and their Standard Retail Price (step 503). The retrieved denomination is calculated by the TS 201 converting the requested denomination for load into the conversion rate based on the rate card table (see FIG. 4) plus any local taxes applicable. The TS 201 then advises the retailer 108 of the available denominations (step 504). The retailer then selects the appropriate denomination and sends a confirmation (step 505) to the TS 201.

On receipt of the confirmation, the TS 201 then validates the request (step 506). If the request is valid, the system then computes the converted cost (step 507) (converted cost=denomination cost x conversion rate). The TS 201 then reviews the retailer's settling account to ensure they have sufficient credit to enable the transaction (step 508). If there is sufficient credit to enable the transaction, the TS 201 proceeds to debit the retailer's settling account (step 509). The TS 201 then sends the reload request (step 510) to the subscriber's home network billing system 210. The billing system 210 then credits the subscriber's airtime allocation with the received load denomination (step 511) and sends a response back to the TS 201 signalling the successful update (step 512). A notification is then sent to the subscriber (step 513) and the retailer (step 514) advising them of successful completion of the reload operation.

If there is no sufficient credit to enable the transaction, the TS 201 will then check if there is a credit provider with whom the retailer has an existing credit agreement. If there is a credit provider with whom the retailer has an existing credit agreement, then the system checks for the amount of credit available for the retailer. If the amount of credit available for the retailer from the credit provider is sufficient to cover the requested transaction, then the system debits this amount from the settlement account of the credit provider and credits the same to the settlement account of the retailer.

If there is no credit provider with whom the retailer has an existing credit agreement, the retailer can then obtain the credit necessary to enable the transaction from a dealer. The settlement account of the dealer is checked if it would be sufficient to provide the credits requested by the retailer. If the settlement account of the dealer is sufficient to provide the credits requested by the retailer, the amount corresponding to the airtime required by the subscriber is debited from the settlement account of the dealer and credited to the settlement account of the retailer.

The TS 201 then proceeds to debit the retailer's settlement account (step 509). The TS 201 sends the reload request (step 510) to the subscriber's home network billing system 210. The billing system 210 then credits the subscriber's airtime with the received load denomination (step 511) and sends a response back to the TS 201 signalling the successful update (step 512). A notification is then sent to the subscriber (step 513), the retailer (step 514), and the credit provider or the dealer, as the case may be, advising them of successful completion of the reload operation.

If the settlement account of the dealer is not sufficient to provide the credits requested by the retailer, the system then checks if there is a credit provider with whom the dealer has an existing credit agreement. If there is a credit provider with whom the dealer has an existing credit agreement, then the system checks for the amount of credit available for the dealer. If the amount of credit available for the dealer from the credit provider is sufficient to cover the requested transaction, then the system debits this amount from the settlement account of the credit provider and credits the same to the settlement account of the dealer. The same amount is then debited from the settlement account of the dealer, and in turn credited to the settlement account of the retailer.

The TS 201 then proceeds to debit the retailer's settlement account (step 509). The TS 201 sends the reload request (step 510) to the subscriber's home network billing system 210. The billing system 210 then credits the subscriber's airtime with the received load denomination (step 511) and sends a response back to the TS 201 signalling the successful update (step 512). A notification is then sent to the subscriber (step 513), the retailer, the credit provider and/or the dealer (step 514), as the case may be, advising them of successful completion of the reload operation.

If the available credit in the settlement account of the retailer and/or the dealer is not sufficient to enable the transaction and there is no credit provider as provided for in the foregoing, the TS 201 then declines the transaction and notifies the retailer of such fact and the reason for the denial.

Once the reload is effected, the TS 201 then proceeds to compute the commissions for the dealer through which the retailer purchases credit and the commission for the host network (step 515). The dealer commission is calculated on the basis of the converted cost multiplied by the agreed commission rate and dealer's share. Likewise the host network commission is calculated on the basis of the converted cost multiplied by the agreed commission rate and host network's share. Once the commissions are calculated the TS 201 proceeds to credit the dealer's and host network's settling accounts (step 516) with the appropriate amounts. Once this is complete, the TS 201 then proceeds to calculate the sales amount for the subscriber's home network (step 517) (home network sales =denomination cost x conversion rate—agent network and dealer commissions). The sales value is then credited to the home networks settling account (step 518).

As can be seen from the above discussion, in order to effect settling of the requested credit value, the participating dealers, retailers of the host networks are required to have a level of available credit within their settling accounts to permit sale and transfer of airtime to subscribers. The system, however, also provides for making credit available through credit providers having existing credit arrangements with the dealers and/or the retailers.

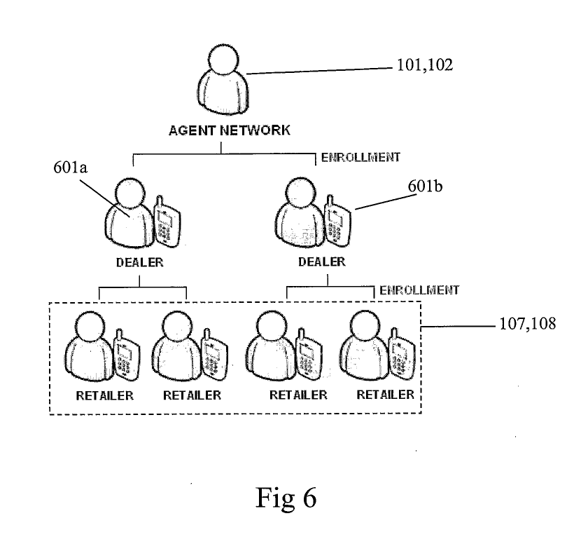

Typically the dealers purchase credit from their local network provider which inturn is provided with an amount of credit as part of their airtime sales commitment upon entry into the partnering agreement. FIG. 6 shows this hierarchy of network providers, dealers and retailers. Under the present system, the network providers 101,102 have the ability to enrol dealers 601a, 601b onto the system, modify the dealer profile and remove dealer from the system. Dealers 601a, 601b are able to enrol a number of retailers 107,108 onto the system. Dealers 601a, 601b sell credit to the retailers as part of the enrolment process.

Retailers 107, 108 earn money based on the percentage mark up applied to the sale of credit to subscribers. For each sale, the retailer makes the enrolling dealer 601a, 601b earns a percentage commission. Network providers 101, 102 then earn a percentage commission on all sales made by dealers to retailers and retailers to subscribers.

Commissions may then be en-cashed by the dealers 601a, 601b and network providers 101, 102. There are a number of commission payment models that may be utilised. For example, commissions may paid back on a just in time basis. The commission scheme utilised to effect transfer is determined by the network providers on entry into the partnering agreement.

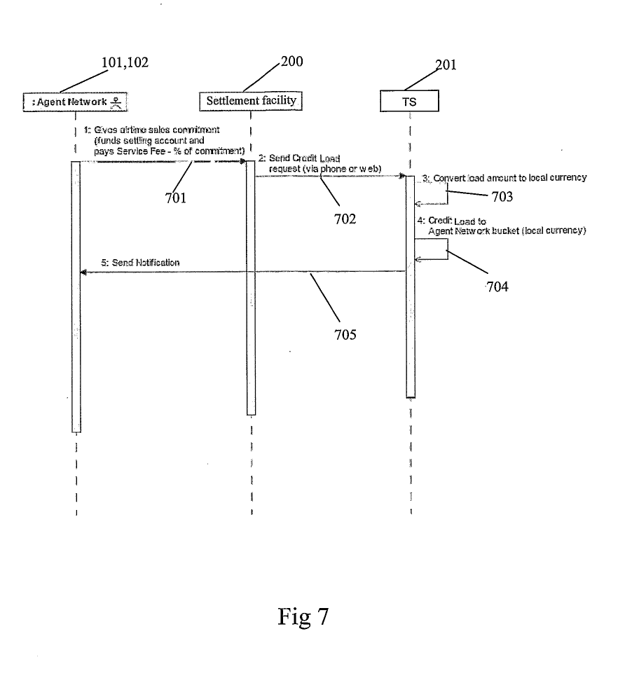

FIG. 7 illustrates the process of crediting a network provider's electronic settling account. Here the provider gives an airtime sales commitment as agreed to in the partnering agreement between the participating networks. The actual value transmitted by the network provider 101,102 is the agreed sales commitment plus the service fee for utilising the settlement facility (preferably in US Dollars). For example if the network provider agrees to a $100, 000 sales commitments and the settlement facility has a 2% commission, the transfer request would in fact be for $102, 000. The settlement facility then converts the received transfer request to a US dollar amount and deducts the required service fee before forwarding the transfer request (step 702) to the TS 201. The TS 201 then converts the received value back to the local currency of the enrolling network provider based on the exchange rate at the date of the original transfer request (step 703). The TS 201 then credits the network provider's settling account with a load denomination equivalent to the received value (step 704) and then sends a notification back to the network provider (step 705) of the deposit of the load credit.

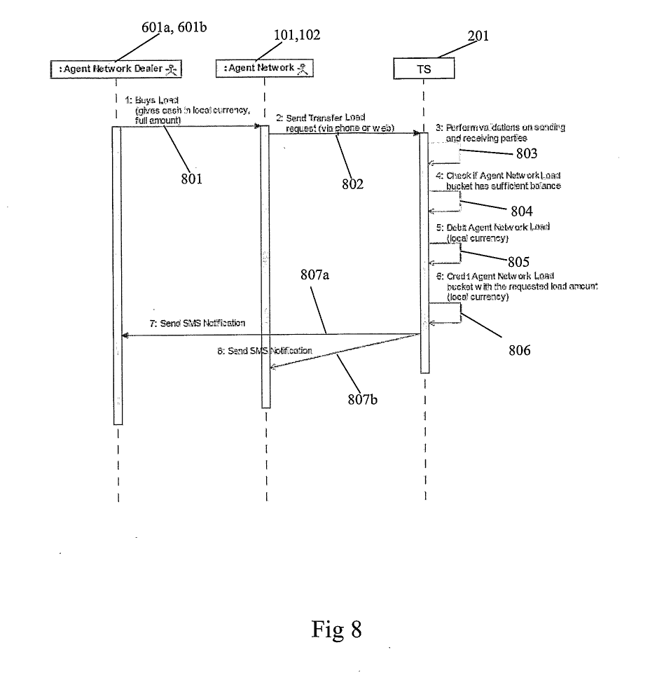

FIG. 8 depicts the transfer of credit between the network provider and an authorised dealer 601a, 601b for the network. Here the dealer 601a, 601b purchases a set amount of credit (step 801) from the network provider for later resale to the dealer's retail network. The network provider then sends a transfer request (step 802) to the TS 201. The TS 201 then performs a validation on the sending and receiving parties (i.e. network provider and dealer making purchase)—step 803. If both parties are validly registered the with the system then the TS 201 proceeds to check if the network provider's settling account has sufficient balance to deliver the requested credit to the dealer (step 804). If the balance of the network provider's account has sufficient credit then the TS 201 debits the network provider's account (step 805) and credits the dealers account with the requested amount of credit (step 806). The TS 201 then sends an SMS, MMS or flash notification message via USSD or STK to both 601a, 601b of the successful completion of the transfer request (steps 807a, 807b respectively). Such message may also be an email or any notification in another form or medium. Similarly, FIG. 8 can also depict the transfer of credit between the network provider and a credit provider, where the credit provider is treated as an authorised dealer

Moreover, FIG. 8 may likewise depict the transfer of credit between the credit provider and a dealer 601a, 601b. This contemplates an instance when the dealer does not have sufficient settlement credits required to consummate a credit load request from its retailers. Here, the dealer 601a, 601b obtains a certain amount of credit (step 801) from the credit provider for subsequent resale to the dealer's retail network. The credit provider then sends a transfer request (step 802) to the TS 201. The TS 201 performs validation on the sending and receiving parties (step 803). If both parties are validly registered with the system, then the TS 201 proceed to check if the credit provider's settlement account has sufficient balance to deliver the requested credit to the dealer (step 804). If the balance of the credit provider's account has sufficient credit then the TS 201 debits the credit provider's account (step 805) and credits the dealer's account with the requested amount of credit (step 806). Otherwise, the transaction is declined. Due notification is then sent to the parties.

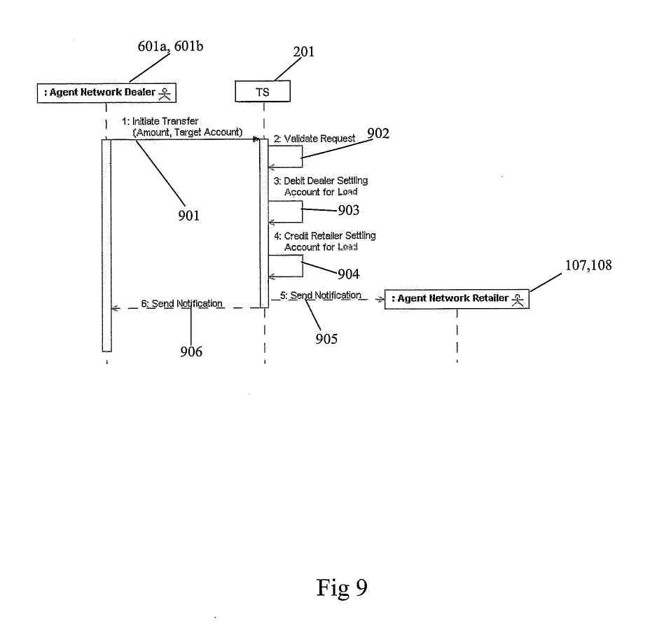

A similar process is employed for the transfer of credit between the dealer 601a, 601b and retailer 107, 108, as shown in FIG. 9. The retailer 107, 108 purchases credit from their specified dealer 601a, 601b. The dealer 601a, 601b initiates a transfer request (step 901) to the TS 201. The TS 201 then proceeds to validate the request (step 902). During the validation the TS 201 firstly checks if the target account and transfer amount is valid. The TS 201 then proceeds to check if the target (retailer) account is enrolled to the source (dealer) account and if the source account has enough credit. Once it is established that the proposed transaction is valid, the TS 201 proceeds to debit the dealer's settling account (step 903) and credit the retailers settling account (step 904). Once the transaction is complete, the TS 201 sends a notification to the retailer 107, 108 (step 905) and to the dealers 601a, 601b (step 906). Another way to look at FIG. 9 is that in the case of transfer of credit between a credit provider 601a, 601b and retailer 107, 108. Instead of outright purchase of credit, however, payment from retailer 107, 108 to the credit provider 601a, 601b may be deferred in such terms as may have been previously agreed upon by both parties.

It should be noted that the transactions between the network provider, dealer, retailer and/or credit provider are performed directly with the TS 201 and do not require the settlement facility to perform a conversion to US dollars. As it will no doubt be appreciated by those skilled in that art as the TS 201 stores the credit values in the home currency of the network then there is no need to perform a currency conversion as all parties in the transactions illustrated in FIGS. 7 to 9 utilise the same currency.

As briefly mentioned above, the TS 201 also maintains a commission and sales accounts as part of the general settling account, which store the commissions conferred and revenues generated by sales to the network service providers, dealers and retailers.

The commissions account is generally only applicable to network providers and dealers as retailers earn revenue through the mark-up they place over the counter sale of the load credit. The values stored in the commissioning accounts for various dealers can be en-cashed at a later date. For example, the network provider may be provided with the ability to deplete the dealer's electronic settlings account for commissions in exchange for cash or load credit.

In such instances the dealer goes to an encashment centre designated by the network provider and requests for redemption of commissions earned. The dealer is presented with the option of taking the commissions in the form of cash or additional load credit. Once the dealer selects the desired form of redemption the network provider initiates the transfer by submitting the dealer's request to the TS 201, which then checks the dealer's commission account and collates the total commissions payable. The TS 201 then proceeds to check if the network provider has sufficient credit in their settling account to cover the commission payable and if so debits the networks provider's account and transfers the appropriate monetary value to an account of the dealer's choice. The TS 201 then proceeds to clear the commissions account of the dealer.

If dealer opts to redeem the commissions in the form of credit, the TS 201 checks the network provider's account to determine whether there is enough credit to complete the transaction. The TS 201 then proceeds to debit the dealer's commissions account and the network service provider's settling account of the corresponding value of load credit, before finally crediting the dealer's settling account with the credit value corresponding to the commission earned by the dealer. The TS 201 then notifies both parties of the successful completion of the transaction.

The en-cashing of commissions at the network service provider level differs slightly to that of the en-cashing scheme between dealer and network service provider. In the case of the network service provider, the settlement facility performs a sweep of all electronic settling accounts for commissions owed to a particular network service provider. The settlement facility then collates these commissions and deposits them into the relevant network provider's bank account. A similar en-cashing process to that discussed in relation to the redemption of commissions owed to a particular network is used to redeem the sales made by a particular network. In this case the settlement facility sweeps the sales account of the relevant network and deposits the appropriate amount into the relevant network provider's bank account. In addition to the above, the system also provides a number of auxiliary functions to the network providers, dealers and retailers are summarised in table 1 below:

TABLE 1
Summary Auxiliary Functions for Account Management on TS
Auxiliary Transactions
Network Provider

| | |
|---|---|
| Inquire Balance: | This transaction allows the Agent Network to view the current balance |
| Load Credit | of its Electronic Settling Account for Credit Load. |
| | Transaction Flow |
| | Agent Network initiates (via mobile or web) Balance Inquiry |
| | transaction for Credit Load and submits transaction. |
| | UTS processes request. |
| | Agent Network receives notification containing balance |
| | information. |
| Inquire Balance: | This transaction allows the Agent Network to view the current balance |
| Commissions | of its Electronic Settling Account for Commissions. |
| | Transaction Flow |
| | Agent Network initiates (via mobile or web) Balance Inquiry |
| | transaction for Commissions and submits transaction. |
| | UTS processes request. |
| | Agent Network receives notification containing balance |
| | information. |
| Inquire Balance: | This transaction allows the Home Network to view the current balance |
| Sales | of its Electronic Settling Account for Sales. |
| | Transaction Flow |
| | Home Network initiates (via mobile or web) Balance Inquiry |
| | transaction for Sales and submits transaction. |
| | UTS processes request. |
| | Home Network receives notification containing balance |
| | information. |

Dealer

| | |
|---|---|
| Inquire Balance: | This transaction allows the Dealer to view the current balance of its |
| Credit | Electronic Settling Account for Credit Load. |
| | Follows the same flow as inquire balance for network provider set |
| | out above. |
| Inquire Balance: | This transaction allows the Dealer to view the current balance of its |
| Commissions | Electronic Settling Account for Commissions. |
| | Follows the same flow as inquire balance for network provider set |
| | out above. |
| Acct. Management: | This transaction allows the Dealer to define a PIN that can be used to |
| Set PIN | protect or ‘Lock’ the Credit Load Menu. This does not apply to web- |
| | based or USSD-based transactions. |
| | Transaction Flow |
| | Dealer selects Set PIN transaction on the Credit Load Menu. |
| | Inputs desired PIN, confirms PIN and submits. |
| | UTS processes request. |
| | Dealer receives a notification for the successful transaction. |
| Acct. Management: | This transaction allows the Dealer to change the current PIN. |
| Change PIN | Transaction Flow |
| | Dealer selects Change PIN transaction on the Credit Load Menu. |
| | Inputs current PIN, new PIN, confirms new PIN and submits. |
| | UTS processes request. |
| | Dealer receives a notification for the successful transaction. |
| Acct. Management: | This transaction allows the Dealer to Lock or Unlock the Credit Load |
| Lock/Unlock | Menu. |
| | Functionalities |
| | Lock hides all options of the Credit Load Menu (e.g. Transfer, |
| | Inquire Balance), except Unlock, Change PIN and Call Hotline |
| | Unlock exposes all options of the Credit Load Menu (when |
| | previously Locked). PIN entry will be required for this transaction |
| | (prerequisite: Dealer has performed Set PIN). |
| Acct. Management: | This transaction allows the Dealer to initiate a voice call to the |
| Call Hotline | assigned after sales group upon selecting the Call Hotline option in |
| | the Credit Load Menu. |

Retailer

| | |
|---|---|
| Inquire Balance: | This transaction allows the Retailer to view the current balance of its |
| Credit | Electronic Settling Account for Credit Load. |
| | Follows the same flow and logic as inquire balance for network |
| | provider set out above. |
| Acct. Management: | This transaction allows the Retailer to define a PIN that can be used |
| Set PIN | to protect or ‘Lock’ the Credit Load Menu. This does not apply to web- |
| | based or USSD-based transactions. |
| | Follows the same flow and logic as per dealer acct management |
| | set pin set out above. |
| Acct. Management: | This transaction allows the Retailer to change the current PIN. |
| Change PIN | Follows the same flow and logic as set out in dealer change pin |
| | set out above. |
| Acct. Management: | This transaction allows the Retailer to Lock or Unlock the Credit Load |
| Lock/Unlock | Menu. |
| | Has the same functionalities as described in dealer lock/unlock set |
| | out above. |
| Acct. Management: | This transaction allows the Retailer to initiate a voice call to the |
| Call Hotline | assigned after sales group upon selecting the Call Hotline option in |
| | the Credit Load Menu. |

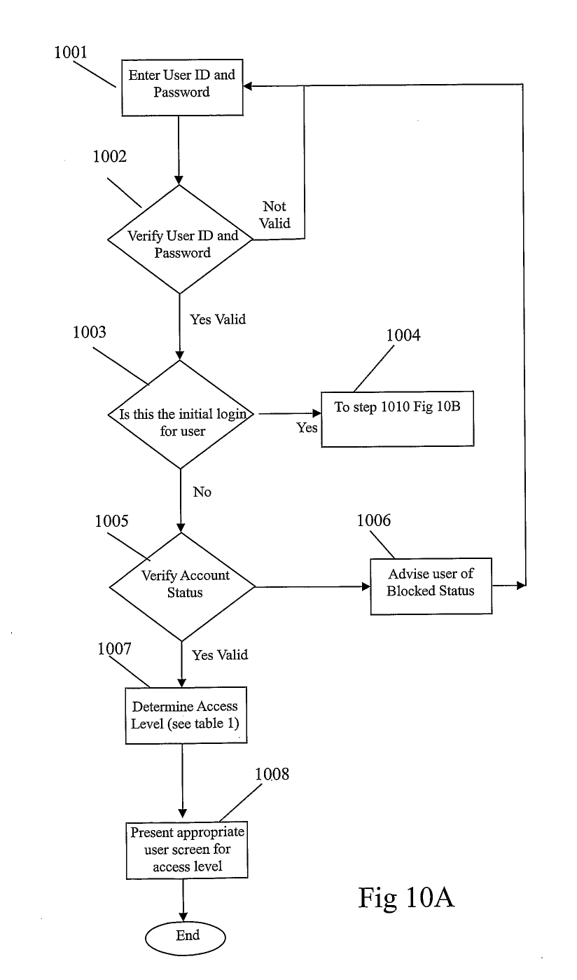

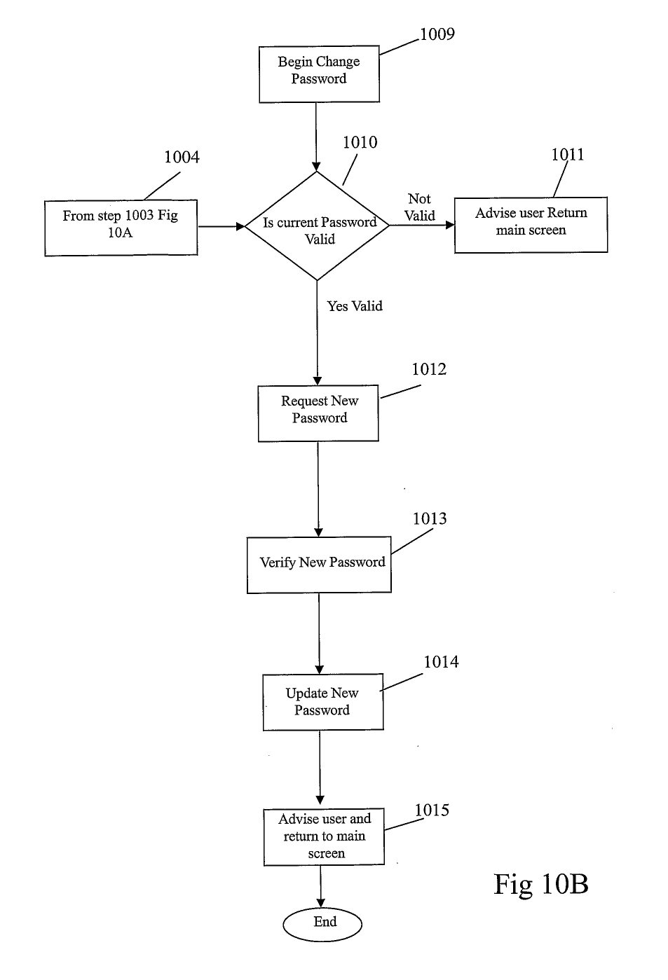

FIG. 10 A depicts one possible configuration of a user login process according to one embodiment of the present invention. To initiate login the user enters their assigned user ID and password (step 1001). The system then determines if the user name and password are valid (step 1002). If so the system then proceeds to check if this is the user first login (step 1003). If it is the users first login, the system then initiates a change password process which is described in greater detail below (see FIG. 10B).

If the user name and password are valid and have been utilised for a previous login, the system proceeds to verify the status of the user's account (step 1005). If the user's account has been blocked, the system advises the user that the account is not valid and returns to the initial login screen (step 1006). If the user's account status is valid, the system then proceeds to verify the users access level (step 1007) and then open the appropriate home screen with the relevant user options (as set out in table 1 above).

FIG. 10B depicts one possible implementation of the change password function. The process is initiated (step 1009) by the user selecting the change password word button. The system then requests the user to verify his/her current password, or in the case where it is initial login discussed above the system verifies whether the assigned password is valid (step 1010). If the password is invalid, the system notifies the user and returns to the main user screen (step 1011).

In the event that the password is valid the system then requests that the user enter the new password (step 1012). The system then requests the user to re-enter the new password for verification (step 1013). Once verified the system updates the password (step 1014), before returning the user to the main user screen (step 1015).

It will be appreciated by those skilled in the art that while the above system has been described in relation to the transfer of credit between networks that the system is equally applicable to the provision of credit within a single network (i.e. wherein the host and home network are the same).

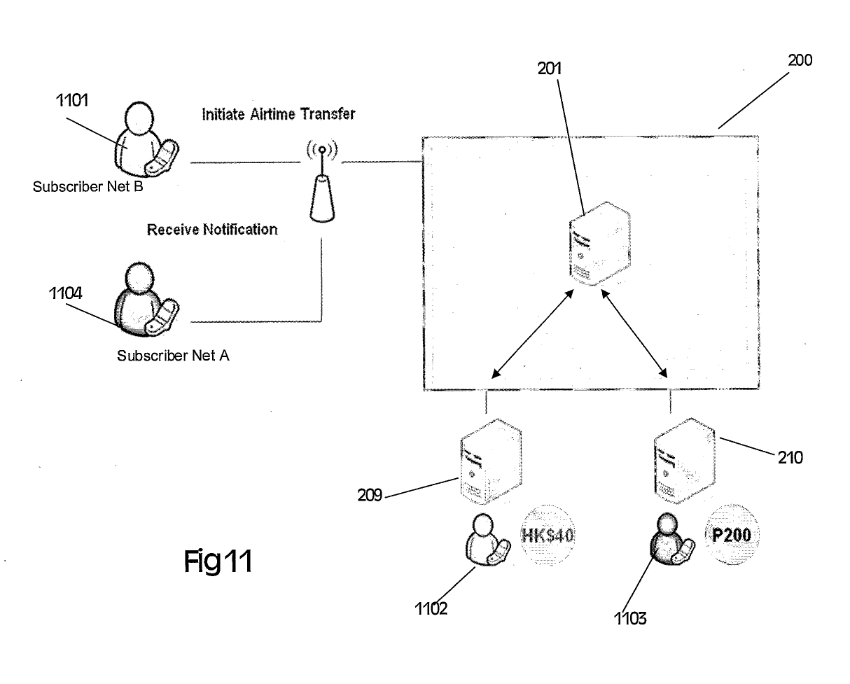

The system also provides subscribers with the ability to transfer airtime charged to a subscriber's post-paid account to a pre-paid account of their choosing or vice versa, via the use of a peer to peer operation 112. Such a transfer scheme is also applicable for the transfer of airtime from one pre-paid subscriber to another pre-paid subscriber. An example of the peer to peer transfer 112 of airtime between subscribers is shown in FIG. 11.

In this example, a subscriber of network B wishes to transfer airtime to a subscriber in network A. The load airtime transaction is initiated through SMS, MMS, WAP, or by sending a keyword or USSD command. Once the request is initiated, the sending party 1101 inputs the desired recipient's 1104 mobile number and airtime denomination. The request is then sent to the TS 201 for processing. The TS 201 then validates the initiating party's and recipient's mobile numbers to determine if they are registered users of the system. If so, the TS 201 debits the initiating party's home network billing system and then credits the airtime to the recipient's home billing system. Both the initiating party and the recipient are then notified of the successful transfer of airtime between the subscribers.

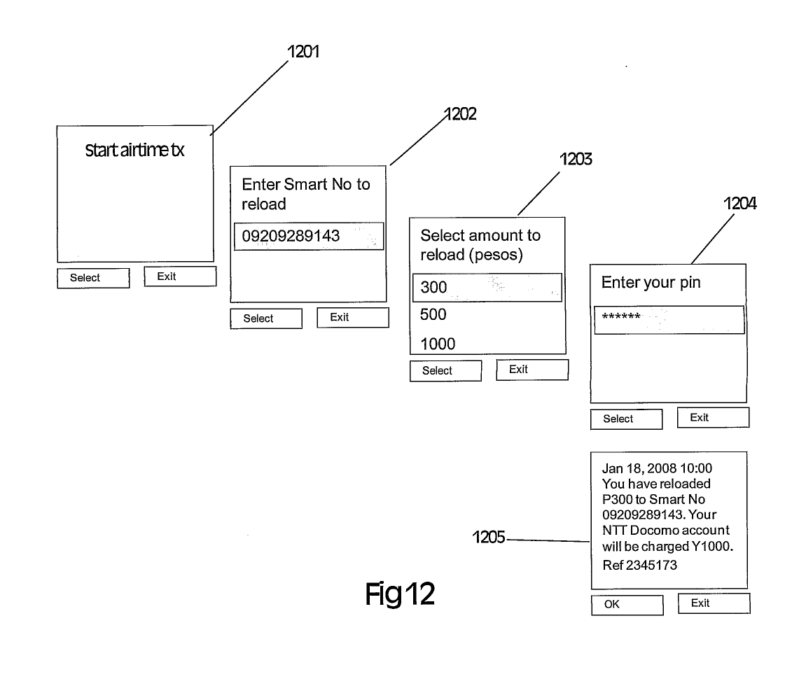

FIG. 12 depicts one example of a series of user screens that may be initiated on a subscriber's handset to effect transfer of airtime. As shown, the user accesses the transfer procedure by selecting it from the user option menu (step 1201). The user is then required to enter the mobile number they wish to transfer airtime to (step 1202). Once the recipient's mobile number has been entered the initiating party is then required to enter the desired transfer amount in the recipient's local currency (step 1203). To confirm the transfer of the requested amount the initiating party is then required to enter a pre-assigned personal identification number (PIN) (step 1204). Once the transfer is effected, the initiating subscriber is then advised of the transfer and the amount billed to their home account (step 1205).

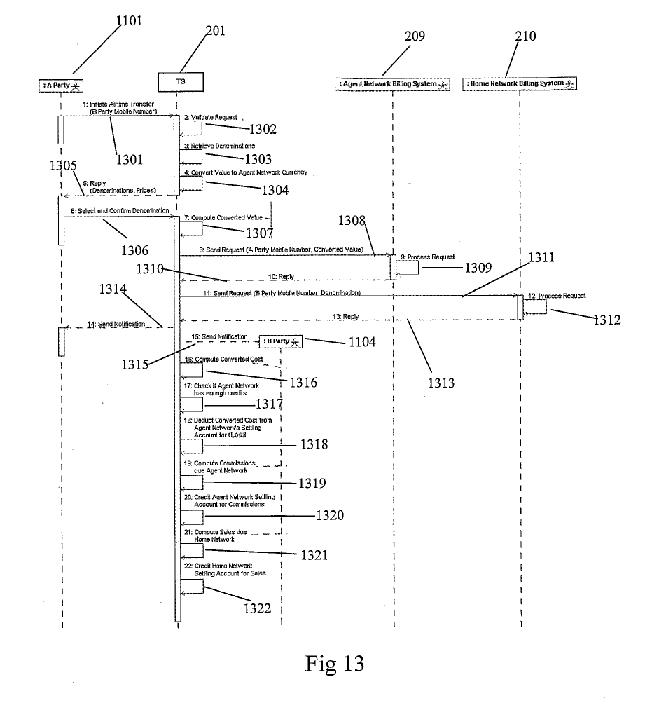

A more detailed view of the transfer process is depicted in FIG. 13 as above, where the initiating party 1101 sends a transfer request 1301 to the TS 201, which then proceeds to validate the request (step 1302). During the validation the TS determines the type of transfer requested e.g. post-paid to prepaid etc. Once the TS 201 has validated the request it proceeds to retrieve the available denominations (step 1303) and convert the retrieved denominations to the host network's currency (step 1304). The TS 201 then sends a reply (step 1305) to the initiating party 1101 advising of the available denominations and the prices associated with each. The initiating party 1101 then selects the desired denomination and confirms the transfer (step 1306).

On receipt of the confirmation the TS 201 then proceeds to calculate a converted value (step 1307 selected denomination×conversion rate). A request is then sent (step 1308 which includes the initiating party's mobile number and the converted value) to the host network billing system 209 which then processes the request (step 1309) and sends a response (step 1310) to the TS 201. The TS 201 then sends a request (step 1311 which includes the recipient's mobile number and the desired denomination) to the recipient's home network billing system 210, which processes the request (step 1312) and sends a response to the TS 201 (step 1313). The TS 201 then sends notifications to the initiating party (step 1314) and the recipient (step 1315) advising of the successful completion of the transaction.

Once the TS 201 has notified the initiating and receiving parties, it then computes the converted cost associated with the transaction (step 1316) (denomination cost×conversion rate). The TS 201 then proceeds to determine if the host network has sufficient credit (step 1317) and if so the TS 201 proceeds to deduct the converted cost from the host networks settling account (step 1318). The system then proceeds to calculate the commissions due to the host network (step 1319) (denomination cost×conversion cost x commission rate). The calculated commission is then credited to the host networks settling account (step 1320). Finally the TS 201 calculates the value of sales due to the home network 210 (step 1321) (denomination cost×conversion rate−commissions) and credits these to the home networks settling account (step 1322).

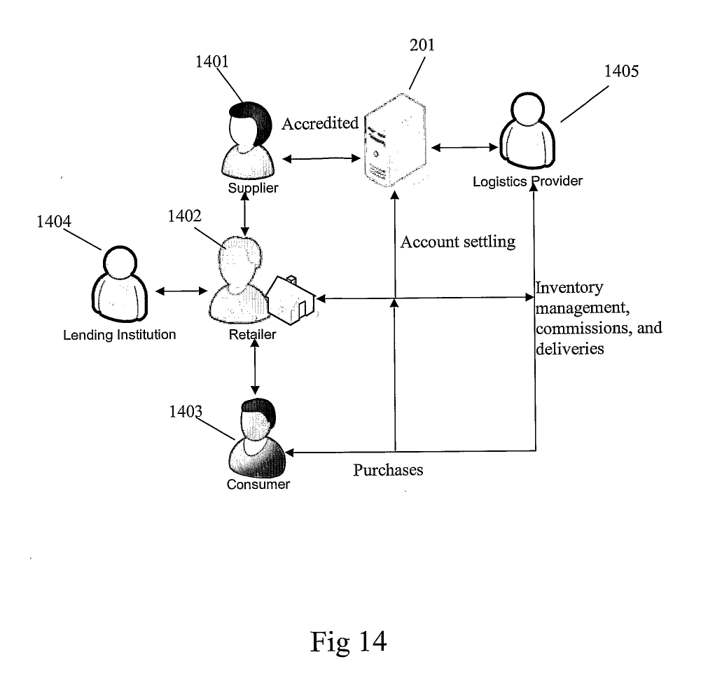

FIG. 14 illustrates a further possible application of the credit provisioning system according to one embodiment of the present invention. Here the system is utilised to purchase various third party goods and services. As shown, a consumer 1403 (e.g. a mobile subscriber, small retail store etc) can access a number of products and services offered by a number of manufacturers 1401 and third party retailers (lead stores) 1402. In this particular example, the credit is exchanged for goods and services as opposed to airtime per the above examples. Consequently the TS 201 not only maintains settling accounts for each user but it is also configured to maintain an inventory of items for sale in the case of manufacturers 1401, the lead stores 1402 and goods purchased in the case of customers 1403. Accordingly the TS 201 manages the purchasing and settlement. In addition to this the TS 201 is also tied to one or more logistic providers 1405. This enables the system to provide inventory tracking and distribution services between the manufacturers 1401, lead stores 1402 and consumers 1403.

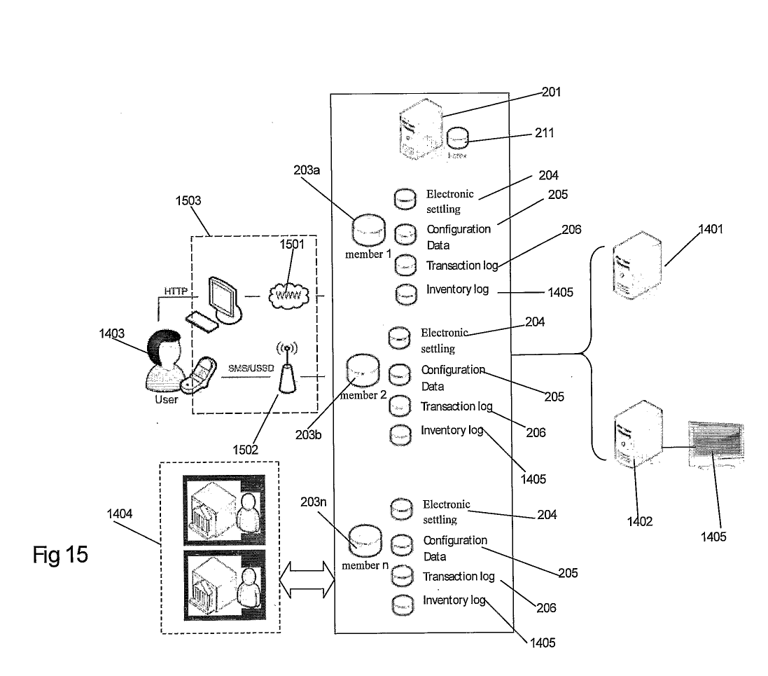

FIG. 15 depicts one example of how a purchase may be affected via the TS 201. As shown a consumer 1403 is free to view the various goods and service on offer from manufacturers 1401 and retailers 1402 via an access point 1503, which in this instance is either a web portal 1501 or mobile network 1502. When the consumer 1403 identifies the item he/she wishes to purchase, he/she initiates a purchasing request to the TS 201. The purchasing request contains the store identification, the item code and the quantity. The system then checks the stores inventory list 1405 contained in their member account to ensure that the item is in stock and if so the system places a purchase order which is saved to the transaction logs of the store and consumer 1403 making the purchase. The store is then notified regarding the pending transaction (email, SMS, MMS etc).

The store then issues a purchase invoice for the transaction. This is then stored in the transaction logs 206 of both the consumer and the issuing store. When the consumer wishes to complete the transaction, the system retrieves the purchase invoice and displays it to the consumer for review. If the consumer is satisfied that the details of the purchase are correct, they then issue a payment request. On receipt of the payment request the system proceeds to check the consumer's settling account to ensure they have sufficient credit to complete the transaction. If the consumer has sufficient credit, the system proceeds to debit the consumer's settling account in the required amount and credit the store's settling account.

The system then notifies the store of the transfer of credit, the store then issues a purchase receipt. The purchase receipt is then sent back to the consumer to verify the successful completion of the transaction. A copy of the purchase receipt is stored in transaction logs 206 of the store and consumer. By maintaining a copy of the receipt within both parties member accounts the system can readily resolve any disputes that may arise over the order etc.

As with the airtime loading system above, the trading system allows distributors to sell goods to dealers who in turn are able to sell to the retailers. Indeed the purchasing process that occurs at the service provider end is similar to the purchasing process occurring between the consumer and retailer. For instance a dealer can review the inventory of a various distributors and select the items he wish to purchase from the distributor.

The supply of the goods from the distributor to the dealer can be administered under two possible usage scenarios. Under the first possible supply model, the dealer may take the goods on credit. In this instance the dealer is free to select the goods they wish to purchase from the distributor. Once the dealer has made their desired selections, he issues a purchase request including the distributor ID, the items for purchase and the quantities of each item required. On receipt of the purchase request the system proceeds to check the dealer's inventory account to ensure that the dealer has sufficient stock to fulfil the request. If there is sufficient stock to fulfil the request, the distributor is then notified of the pending transaction (via email, SMS etc). The distributor issues a purchase invoice for the requested goods, the invoice is then saved to the transaction log of the distributor and dealer. The stock items are then debited from the distributor's inventory list and credited to the dealer's inventory list.

The dealer is then free to sell the stock items to retailers, the stock items are on sale at suitable mark up. On sale of the goods to the retailers, the dealer's settling account is credited in the sales amount. To effect settlement with the distributor, the dealer sends a request to the system to retrieve the relevant purchase invoice utilising an access code or keyword associated with the purchase invoice number. The system then checks if the invoice number is valid and then verifies if there is sufficient credit in the dealer's settling account to complete the transaction. If so the system debits the dealer's settling account and credits the distributor's settling account. Both the dealer and distributor receive notifications from the system on successful completion of the transaction.

The alternate usage model is that of a commission model. Here the dealer purchases an agreed volume of inventory from the distributor. In this instance, the dealer sends a purchase order including the distributor ID and agreed purchase amount to the system, the system then checks the dealer's account to ensure that there is sufficient credit to proceed with the transaction. If so the system proceeds to debit the dealer's settling account and credits the distributor's settling account. The distributor then advises the system of the stock items to transfer from its inventory listing to the dealer's inventory listing. On transfer of the stock items, the system provides the dealer with a listing of the incoming stock. The dealer is then free to sell the stock at the recommend price for each sale. The dealer's settling account is credited by the amount of the recommended sale price set by the distributor. A corresponding entry is also made in the dealer's commissions account in accordance with the agreed commissioning scheme in place between the dealer and the distributor.

The commissions may be redeemed on a periodic basis or at the initiation of the dealer. In the case of a periodic redemption process, the system performs a sweep of the dealer's account for any unpaid commissions (i.e. values stored in dealers commissions account). The settlement facility then collates these commissions and arranges for transfers of the appropriate funds to be transferred from the relevant distributor's settling account into the dealer's selected bank account. The system then notifies the dealer and the distributor of the transfer.

In the case of a dealer initiated transfer, the dealer sends a transfer request to the system which then verifies whether the dealer and the distributor are validly registered members of the system. If so the system then proceeds to check if the distributor's settling account has sufficient funds to affect the transfer of the required funds to the dealer. In the event that the distributor's account contains sufficient credit, the system arranges transfer of the appropriate funds to the dealer's bank account. The system then notifies the distributor and dealer of the transfer.

As shown, the system may also be linked to various financial institutions 1404. This enables the system to en-cash the credit accumulated by retailers, dealers and distributors directly into the account of their choosing. In addition, linking into various financial institutions 1404 provides the consumer with the option to purchase credit directly from the credit facility. For example, a consumer can logon to their account with the settlement facility and request additional credit, the system then debits the selected bank account of the consumer in the amount of the credit request and then updates the amount of available credit in the consumers settling account.

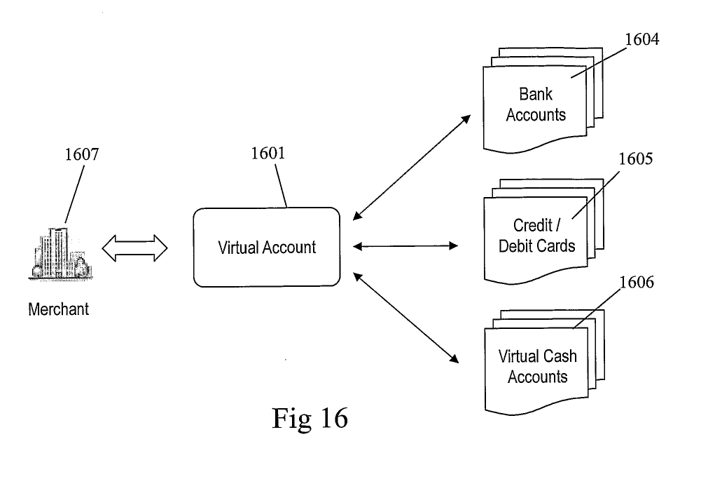

FIG. 16 depicts an example of how the member's account on the TS 201 may be linked to various accounts owned by an individual to effect transactions with various parties. As shown, bank accounts 1604, credit or debit cards 1605, and virtual cash accounts 1606 are all linked or bound to a member's account which acts as a virtual account 1601. The binding of the accounts in this manner effectively blurs the difference between the virtual account 1601 and the accounts to which it is linked, because the virtual account serves as proxy to the bound accounts. Thus the virtual account merely serves as a repository of credentials for the bound accounts. Any transactions via the virtual account causes the translation or look-up of the account credentials mapped or bound to virtual account to permit the system to negotiate approval of the transaction as if directly transacting using the bound account. A settlement account is provided at the merchant 1607 backend, so that the system can calculate and credit commissions and whatever fees that are due to each party involved in the transaction. In any transaction between the member and the merchant 1607, the bank accounts 1604, credit or debit cards 1605, or virtual cash accounts 1606 are transparent to the merchant 1607 as these are encapsulated in virtual account 1601.

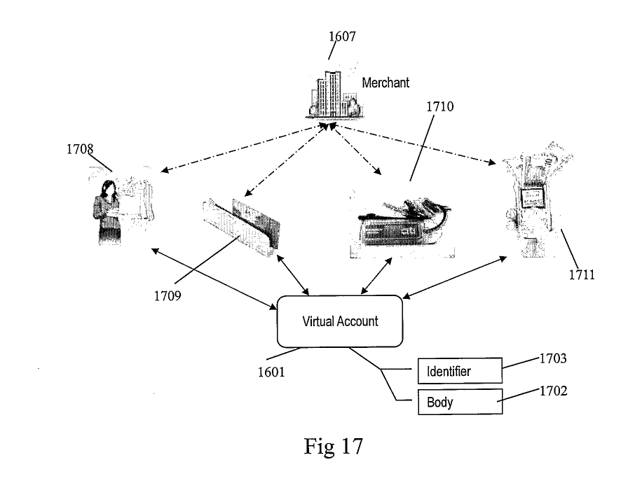

FIG. 17 depicts one example of how transactions can be made using the virtual account 1601. In this particular case, the virtual account is a physical device that is associated with the virtual account 1601. As shown the physical device may include, but is not limited to, a magnetic stripe card 1709 which needs to be swiped at a magnetic card reader at the merchant 1607 side, an RFID key chain 1710 for contactless transaction, a contactless or proximity card, smart card or the like.

The system may be further adapted to allow over-the-air transactions, for example via a mobile phone 1711. In such cases, the virtual account 1601 is associated with the mobile phone 1711, sharing identifiers such as but not limited to SIM (Subscriber Identity Module), account, and IMEI (International Mobile Equipment Identity) numbers and similar information.

In the above scenarios, the merchant 1607 is actually transacting with the virtual account 1601 through a physical device. However the use of such a physical device is not always necessary. As shown the virtual account 1601 has two associated properties, the identifier 1703 and the body 1702. Utilizing the identifier 1703 it is possible to conduct a transaction without an associate physical device. In such instances the indentifer 1703 is inputted directly into the merchant's payment gateway 1708 which could form part of a storefront or website.

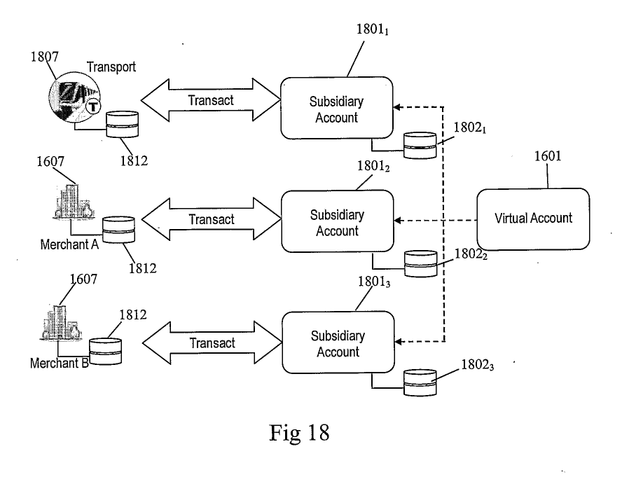

FIG. 18 depicts yet a further example of how the virtual account 1601 may be utilized to conduct transactions with various merchants 1607. In this particular example several subsidiary accounts 1801₁, 1801₂, 1801₃ are created from a virtual account. Each subsidiary account 1801₁, 1801₂, 1801₃ is coupled to a subsidiary settlement account 1802₁, 1802₂, 1802₃. An account holder may transfer funds in any amount from his nominated account through the virtual account 1601 to the subsidiary settlement account 1802₁, 1802₂, 1802₃ within the subsidiary account 1801₁, 1801₂, 1801₃. Transaction limits, may be imposed on any subsidiary settlement account 1802₁, 1802₂, 1802₃ just as a credit card account could have a credit limit, but which may also include other parameters of limitation such as frequency or time of use. Funds available through the virtual account 1601 may be converted to an intermediate value, which could be any common or agreed currency base in the foreign exchange or a non-currency-based numeric representation based on an arranged conversion factor, and transferred directly from the fund source to the specific subsidiary accounts in such amount or quantity as may correspond to the transferred fund in the intermediate value.

When transacting with a merchant 1607 via the subsidiary account 1801, 1801₂, 1801₃, the subsidiary settlement account 1802₁, 1802₂, 1802₃ is debited with the transaction value, which is in turn credited to the merchant settlement account 1812. Such transaction contemplates only instances where the merchant requires a specific or dedicated settlement account; otherwise, the transaction should draw funds directly from the nominated fund source through the virtual account 1601 and not from the subsidiary settlement account 1802₁, 1802₂, 1802₃.

One advantage to the use of such subsidiary account 1801₁, 1801₂, 1801₃ may be created for a specific purpose. For instance, a transportation system 1807 (i.e. specific class of merchant 1607) may require a micropayment system with a co-branded access card. A subsidiary account 1801₁ may, be created with a subsidiary settlement account 1802₁ which is mapped to the settlement account of the transport system 1812. A metro card co-branded with the transportation system may then be issued, the metro card being linked to the subsidiary account 1801₁. This metro card is then used for entry and exit to the facilities of the transportation system 1807, and every time it is used, the subsidiary settlement account 1802₁ is debited with the value corresponding to the fare for travel, which in turn is credited to the settlement account 1812 of the transportation system 1807. When the value contained in the subsidiary settlement account 1802₁ is insufficient for a particular transaction, it may be replenished or topped up with credit from the nominated fund source through the virtual account 1601, provided that such is within the parameters of limitations imposed on the subsidiary account 1801₁.

In the event that the metro card is used, for instance, in a transaction such as purchase of goods where there is no specific subsidiary settlement account 1802₁ from which the value of the transaction may be debited the system firstly determines the point of use from which the source of funds or credits is based and then draws funds to cover the transaction directly from the nominated fund source through the virtual account 1601.

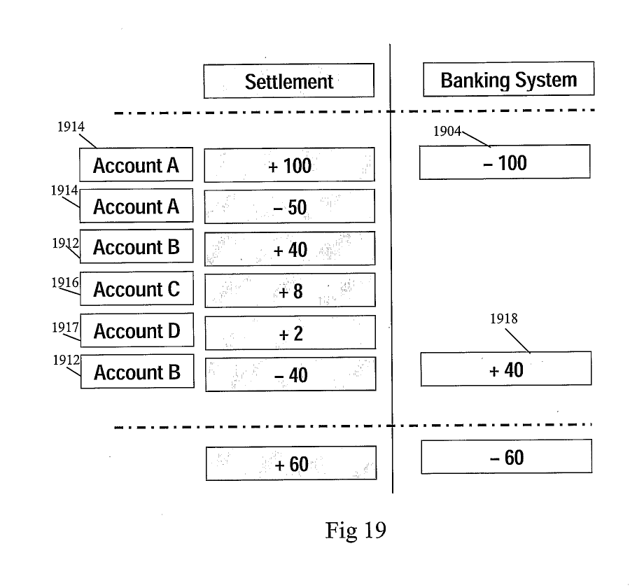

With reference to FIG. 19, there is illustrated an example of how the automatic payment of commissions to the appropriate party is done through the settlement accounts. As shown is an individual A transferring the amount of $100 from his bank account 1904 through the virtual account 1601, to his settlement account 1914. Assuming one-to-one equivalency between the currency in use and the credit units, the value 100 will be debited from the bank account 1904 and credited to the settlement account 1914.

If individual A transacts with merchant B for example in the amount of 50 credits, the amount will be debited from his settlement account 1914. The transaction between may then trigger automatic payment of commissions, assuming that for such transaction, commissions are due to logistics provider (Account C) and supplier (Account D). As shown, 40 credits are credited to the settlement account of merchant B 1912 less the commissions for the parties to whom commission is due. In this example, the settlement account of logistics provider C 1916 is credited with 8 credits, while the settlement account of supplier D 1917 is credited with 2 credits, their respective commissions. Assuming further that merchant B decides to cash-in on his settlement credits, the amount of 40 credits which is the current value of his settlement account, shall be debited from said account 1912, and credited in the amount of its monetary equivalent 40 dollars to his bank account 1918. For purposes of accounting, it has been shown in FIG. 19 that transactions in both the settlement and banking systems balance out.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

What is claimed is:

1. A system for providing credit to a subscriber, said system including: a plurality of networks, each of said networks supporting a plurality of subscribers; a central settlement facility coupled to each network within the plurality of networks, said central settlement facility maintaining a plurality of subscriber accounts and wherein the central settlement facility is adapted, on receipt of a request for credit from a subscriber, to: convert the request for credit to an intermediate value; obtain credit from a credit provider with said intermediate value; credit an account held by the subscriber on the settlement facility with an amount equivalent to the request for credit; and advise the subscriber of the approval of the request for credit.

2. The system of claim 1 wherein the central settlement facility includes at least one server, the at least one server being adapted to maintain the plurality of subscriber accounts and negotiate the provision of credit from the credit provider.

3. The system of claim 1 wherein the request for credit is transmitted to the central settlement facility in the local currency of the network from which the subscriber makes the request.

4. The system of claim 1 wherein the central settlement facility is coupled to a foreign exchange trading service.

5. The system of claim 4 wherein the intermediate value is a monetary value equivalent of the request for credit.

6. The system of claim 1 wherein the request for credit is transmitted to the central settlement facility by the subscriber via a web portal, ATM, POS, kiosk, SMS, MMS, WAP, On Device Portal (ODP) or USSD command.

7. The system of claim 1 wherein the central settlement facility contains a central clearing house.

8. The system of claim 1 wherein the request for credit includes providing a cash payment for a predetermined credit value to a third party broker having an account with the central settlement facility.

9. The system of claim 8 wherein the system is configured to transfer credit from a credit provider's account to the subscriber's account.

10. The system of claim 8 wherein the system is configured to allow the third party broker to negotiate the request for credit with the credit provider to obtain the best rate for the subscriber.

11. The system of claim 10 wherein the system is configured to credit the third party broker with a predetermined commission for brokering the provision of credit for the subscriber.

12. The system of claim 8 wherein the system is configured to credit the third party credit provider with a predetermined commission for the sale of credit to the subscriber.

13. The system of claim 1 wherein the advice regarding approval of the request for credit is sent in the form of an email, SMS, MMS, IP and flash message via USSD or STK.

14. The system of claim 13 wherein the advice includes the amount credited to the subscriber's account and the amount charged to the subscriber for obtaining the requested amount of credit.

15. The system of claim 1 wherein the credit obtained by the subscriber is exchanged through the central settlement facility for goods and/or services offered by one or more third parties registered with the central settlement facility.

16. A system for providing airtime to a subscriber of a communications service, said system including: a plurality of networks each of said networks supporting a plurality of subscribers; a central settlement facility coupled to each network within the plurality of networks, said central settlement facility maintaining a plurality of subscriber accounts and wherein the central settlement facility is adapted, on receiving a request for airtime from a subscriber on a first network, to: convert the request for airtime to an intermediate value; obtain airtime from a second network with said intermediate value; credit the subscriber with the requested amount of airtime; and advise the subscriber of the approval of the airtime request.

17. The system of claim 16 wherein the first network is the network currently hosting the subscriber and the second network is the subscriber's home network.

18. The system of claim 16 wherein the request for airtime is transmitted to the central settlement facility in the local currency of the first network.

19. The system of claim 16 wherein the central settlement facility is coupled to a foreign exchange trading service.

20. The system of claim 19 wherein the intermediate value is a monetary equivalent of the request for airtime.

21. The system of claim 16 wherein the request for airtime is transmitted to the central settlement facility by the subscriber via a web portal, ATM, POS, kiosk, SMS, MMS1 WAP1 On Device Portal (ODP) or USSD command.

22. The system of claim 16 wherein the subscriber is a post-pay customer of the second network.

23. The system of claim 22 wherein the system is configured to debit the subscribers post-pay account on the second network in the local currency of the second network for the requested airtime.

24. The system of claim 16 wherein the subscriber is a prepaid customer of the second network.

25. The system of claim 24 wherein the request for airtime includes providing a cash payment to a third party within the first network in a first currency said third party having a subscriber account with the credit facility.

26. The system of claim 25 wherein the system is configured to debit the third party's subscriber account in the amount of the cash payment, and credit the subscriber's pre-paid account in the amount of the cash payment in the local currency of the network on which the pre-paid account is maintained.

27. The system of claim 16 wherein the advice regarding approval of the request for credit is sent in the form of an email, SMS, MMS, IP, and flash message via USSD or STK.

28. The system of claim 27 wherein the advice includes the amount of airtime credited to the subscriber's home account and the amount charged to the subscriber for obtaining the requested amount of airtime.

29. A method of facilitating the provision of credit to a selected subscriber via a central settlement facility coupled to a plurality of networks, wherein each of said networks supports a plurality of subscribers said method including the steps of: receiving at a central settlement facility a request for credit from at least one subscriber; determining if the subscriber has an account with the central settlement facility; converting the request for credit to an intermediate value on determining that the subscriber maintains an account with the central settlement facility; obtaining credit from a credit provider based on the intermediate value; crediting the subscriber's account with the central settlement facility in the amount of requested credit; and advising the subscriber of the approval of the request for credit.

30. The method of claim 29 wherein the request for credit in the form of a keyword(s) sent via a web portal, wireless terminal, an ATM, a POS, or a kiosk.

31. The method of claim 29 wherein the request is in the form of an SMS, MMS, WAP, ODP or USSD command sent from a mobile handset.

32. The method of claim 29 wherein the step of converting the request for credit to an intermediate value includes converting the request for credit to an equivalent monetary value.

33. The method of claim 29 wherein the step of obtaining credit includes debiting the credit provider's account on the central settlement facility in the amount of the request for credit and billing the subscriber's account.

34. The method of claim 33 wherein the step of billing the subscriber's account includes converting the intermediate value to the subscriber's local currency.

35. The method of claim 29 further including the step of exchanging the credit contained in a subscriber's account for goods and/or services provided by third parties registered with the central settlement facility.

36. The method of claim 29 wherein the step of advising includes sending an electronic notification to the subscriber.

37. A method of providing airtime to a subscriber of a mobile communications network via a central settlement facility coupled to a plurality of mobile communications networks wherein each of the plurality of mobile communications networks supports a plurality of subscribers, said method including the steps of: receiving at the central settlement facility from at least one subscriber on a first network a request for airtime from a second network within the plurality of mobile communications networks coupled to the settlement facility; determining if the subscriber has an account with the central settlement facility; converting the request for airtime to an intermediate value on determining that the subscriber maintains an account with the central settlement facility; obtaining airtime from the second network based on the intermediate value; crediting the subscriber's account with the central settlement facility the amount of requested airtime; and advising the subscriber of the approval of the request for airtime.

38. The method of claim 37 wherein the request for credit in the form of a keyword(s) sent via a web portal, wireless terminal, an ATM, a POS, or a kiosk.

39. The method of claim 37 wherein the request is in the form of an SMS, MMS, WAP, ODP or USSD command sent from a mobile handset.

40. The method of claim 37 wherein the first network is the network currently hosting the subscriber and the second network is the subscriber's home network.

41. The method of claim 40 wherein the request for airtime is in the first network's local currency and the step of converting to an intermediate value includes converting the request for airtime from the first network currency to an equivalent monetary value.

42. The method of claim 37 wherein the subscriber is a postpaid customer of the second network.

43. The method of claim 42 wherein further including the step of debiting the subscriber's post-paid account on the second network in the local currency of the second network for the requested airtime.

44. The method of claim 37 wherein the subscriber is a prepaid customer of the second network.

45. The method of claim 44 wherein the step of requesting airtime includes providing a cash payment to a third party within the first network in a first currency, said third party having a subscriber account with the settlement facility.

46. The method of claim 45 further including the steps of debiting the third party's subscriber account in the amount corresponding to the requested airtime, and crediting the subscriber's pre-paid account in the amount corresponding to the requested airtime in the local currency of the network on which the pre-paid account is maintained.

47. The method of claim 37 wherein the step of advising includes sending an electronic notification to the subscriber.

48. A system for facilitating transactions between subscribers, said system including: a plurality of networks, each of said networks supporting a plurality of subscribers; a central settlement facility coupled to each network within the plurality of networks, said central settlement facility maintaining a plurality of subscriber accounts and wherein the central settlement facility is adapted, on receipt of a request for subscriber, to: bind one or more credit and/or debit accounts of a subscriber to the account maintained by subscriber on the central settlement facility, wherein binding includes creating a virtual account having a unique set of credentials, said virtual account being utilised by the subscriber to conduct transactions with a plurality of third parties registered with the central settlement facility; and wherein the central settlement facility is further adapted to negotiate approval of said transactions with the appropriate credit and/or debit accounts of the subscriber bound to the virtual account.

49. The system of claim 48 wherein creating the virtual account requires the subscriber to designate a default account from the one or more credit and/or debit accounts via which negotiating approval of all transactions is primarily performed.

50. The system of claim 48 wherein the virtual account is link to a physical medium to facilitate transaction with third parties registered with the central settlement facility.

51. The system of claim 50 wherein the physical medium is a magnetic stripe card, smart card, contactless card or RFID tag.

52. The system of claim 50 wherein the physical medium is the subscriber's mobile telephone.

53. The system of claim 48 wherein the central settlement facility is adapted to create a set of subsidiary accounts from the virtual account each subsidiary account including a subsidiary settlement account.

54. The system of claim 53 wherein each subsidiary accounts is associated with a third party selected from the plurality of third parties registered with the central settlement facility.

55. The system of claim 54 wherein creating subsidiary accounts from the virtual account requires the subscriber to designate a default account from the one or more credit and/or debit accounts via which negotiating approval of all transactions conducted through the subsidiary settlement accounts is primarily performed.

56. The system of claim 54 wherein each subsidiary account is linked to a physical medium to facilitate transaction with the third party associated with the subsidiary account.

57. The system of claim 56 wherein the physical medium is a magnetic stripe card, smart card, contactless card or RFID tag.

58. The system of claim 56 wherein the physical medium is the subscriber's mobile telephone.

59. The system of claim 48 wherein the transactions between the subscriber and third parties is conducted via a web portal, ATM, POS, kiosk, SMS, MMS, WAP, On Device Portal (ODP) or USSD command.

60. The system of claim 53 wherein the transactions between the subscriber and third parties is conducted via a web portal, ATM, POS, kiosk, SMS, MMS, WAP, On Device Portal (ODP) or USSD command.

61. A method of facilitating transactions between a subscriber and third parties via a central settlement facility coupled to a plurality of networks, wherein each of said networks supports a plurality of subscribers, said method including the steps of: creating at the central settlement facility a virtual account for the subscriber; binding one or more credit and/or debit accounts of a subscriber to the virtual account; conducting via the virtual account transactions with a plurality of third parties registered with the central settlement facility; and negotiate approval of said transactions with the appropriate credit and/or debit accounts of the subscriber bound to the virtual account.

62. A method of facilitating transactions between a subscriber and third parties via a central settlement facility coupled to a plurality of networks, wherein each of said networks supports a plurality of subscribers, said method including the steps of: creating at the central settlement facility a virtual account for the subscriber; receiving at the central settlement facility from at least one subscriber a request for airtime load; determining if the subscriber has an account with the central settlement facility; obtaining the requested airtime from a credit provider; crediting the subscriber's account with the central settlement facility with the requested airtime load; and wherein the at least one subscriber exchanges the requested airtime via the virtual account for third party goods and/or services.

63. The method of claim 62 wherein the request for airtime load or transfer of airtime load is a monetary value.

64. The method of claim 63 wherein the central settlement facility is coupled to a foreign exchange trading service.

65. The method of claim 62 wherein the request for airtime is transmitted to the central settlement facility by the subscriber via a web portal, ATM, POS, automated kiosk, SMS, MMS, WAP, On Device Portal (ODP) or USSD command.

66. The method of claim 62 wherein the virtual account is linked to a physical medium to facilitate transaction with third parties registered with the central settlement facility.

67. The method of claim 66 wherein the physical medium is a magnetic stripe card, smart card, contactless card or RFID tag. 46

68. The system of claim 66 wherein the physical medium is the subscriber's mobile telephone or internet plug-it device.

69. A system for facilitating transactions between subscribers, said system including: a plurality of networks, each of said networks supporting a plurality of subscribers; a central settlement facility coupled to each network within the plurality of networks, said central settlement facility maintaining a plurality of subscriber accounts and wherein the central settlement facility is adapted, on receipt of a request for subscriber, to: receive from at least one subscriber a request for airtime load; determine if the subscriber has an account with the central settlement facility; obtain the requested airtime from a credit provider; credit the subscriber's account with the central settlement facility with the requested airtime load; and wherein the at least one subscriber exchanges the requested airtime load via the virtual account for third party goods and/or services.

70. The system of claim 69 wherein the request for airtime or transfer of airtime is a monetary value.

71. The method of claim 70 wherein the central settlement facility is coupled to a foreign exchange trading service.

72. The system of claim 69 wherein the virtual account is linked to a physical medium to facilitate transaction with third parties registered with the central settlement facility.

73. The system of claim 72 wherein the physical medium is a magnetic stripe card, smart card, contactless card or RFID tag. 47

74. The system of claim 72 wherein the physical medium is the subscriber's mobile telephone or internet plug-it device.
